(19) United States
(12) Patent Application Publication
(10) Pub. No.: US 2014/0374329 A1
(43) Pub. Date: Dec. 25, 2014

(54) SEWAGE TREATMENT SYSTEM

(71) Applicant: CHANGWON ENVIRONMENT IND. CO., LTD., Gyeongsangnam-do (KR)

(72) Inventor: Chan Hoo Park, Busan (KR)

(21) Appl. No.: 14/370,967

(22) PCT Filed: Mar. 6, 2013
(86) PCT No.: PCT/KR2013/001789

§ 371 Date: Jul. 8, 2014

(30) Foreign Application Priority Data
Mar. 7, 2012 (KR) 10-2012-0023174

(51) Int. Cl. C02F 1/00; C02F 1/461

(52) U.S. Cl. CPC C02F 1/008; C02F 1/461; C02F 2103/08
USPC 210/110; 204/267

(57) ABSTRACT

Disclosed is a sewage treatment system which is capable of treating a large amount of sewage, has a compact structure, and improves sewage treatment capacity in an eco-friendly manner by using an electrolysis unit and a reducing agent supply device. The sewage treatment system according to the present invention comprises a first system (S1) and a second system (S2). The first system (S1), which transports sewage and sea water to an electrolysis unit (E), includes: a first detection member (10); a second detection member (20) disposed above the first detection member (10) for water level detection; a third detection member (30) disposed above the second detection member (20) for water level detection; a fourth detection member (40) disposed above the third detection member (20) for water level detection; a first sea water control unit (V1) supplying sea water when the water level is detected by the first detection member (10) and blocks the sea water when the water level is detected by the second detection member (20); and to first pump (P1) which begins operation to transport the sewage and sea water to the electrolysis unit (E) when the water level is detected by the third detection member (30) and stops operation when the water level is detected by the first detection member (10). The second system (S2), which discharges the treated water flowing in from the electrolysis unit (E) to the outside, includes: a fifth detection member (50); a sixth detection member (60) disposed above the fifth detection member (50) for water level detection; a seventh detection member (70) disposed above the sixth detection member (60) for water level detection; and a second pump (P2) which begins operation to discharge the treated water to the outside when the water level is detected by the sixth detection member (60) and stops operation when the water level is detected by the fifth detection member (50).

### CROSS-REFERENCE TO RELATED APPLICATIONS

This application is a U.S. national stage application under 35 USC. §371 (c) of PCT Application No. PCT/KR2013/001789, entitled “SEWAGE TREATMENT SYSTEM,” filed on Mar. 6, 2013, which claims priority under 35 U.S.C. §119 Korean Patent Application No. 10-2012-0023174, filed on Mar. 7, 2012 in the Korean Intellectual Property Office, the disclosures of which are incorporated by reference herein in their entireties.

### TECHNICAL FIELD

The present invention relates to a sewage treatment system, and more specifically, to a compact sewage treatment system having multiple water level detection devices installed at different positions. The sewage treatment system may automatically detect the inflow and discharge of sea water and sewage thereby to efficiently perform sewage treatment. The sewage treatment system includes an electrolysis unit and a reducing agent supply device to reinforce eco-friendly sewage purification capability and to allow the treatment of a large amount of sewage.

### DISCUSSION OF RELATED ART

Methods of purifying humans' excreta may be generally classified into chemical methods and electrolysis methods. The chemical methods use chemicals to decompose excreta, and thus, an increase in the amount of excreta may result in more chemicals being demanded, thus causing another type of environmental pollution. Such chemical methods are limited by inefficiency in light of speed or time in treating a large amount of excreta.

To address such weakness, electrolysis-based excreta treatment has been adopted, but the efficiency and reduction in volume of the structure relies on the configuration of a device for use in electrolysis. Accordingly, the present invention provides an efficient sewage treatment system with compact structure.

### SUMMARY

An object of the present invention is to provide a practical sewage treatment system with compact structure, which may treat sewage containing a large amount of excreta, unlike the above-described, conventional sewage treatment systems.

Another object of the present invention is to provide a sewage treatment system that includes an electrolysis unit and a reducing agent supply device to increase its sewage treatment capability in an eco-friendly manner, as well as providing the above functions.

Still another object of the present invention is to provide a space-customized sewage treatment system that may be separated or integrated as a single body depending on the space in which the sewage treatment system is to be installed.

Yet still another object of the present invention is to provide an automatic control-type sewage treatment system with no clogging in the pump of the sewage treatment system, thus allowing for smooth sewage treatment irrespective of the type of a toilet into which excreta is flushed.

Yet still another object of the present invention is to provide a sewage treatment system in which supply of sea water is automatically controlled in order to increase the electrolysis efficiency of sewage treatment.

Depending on how to configure each element in a sewage treatment system for operation of the sewage treatment system, the efficiency of the sewage treatment system may be increased, and the structure of the sewage treatment system may be rendered compact. The present invention provides a sewage treatment system that is eco-friendly and that allows for more efficient sewage treatment capability and customized design.

To achieve the above objects, according to an embodiment of the present invention, a sewage treatment system comprises a first system (S1), and a second system (S2), wherein the first system (S1) transports sewage and sea water to an electrolysis unit (E), the first system (S1) including a first detection member (10), a second detection member (20) disposed above the first detection member (10) for water level detection, a third detection member (30) disposed above the second detection member (20) for water level detection, a fourth detection member (40) disposed above the third detection member (30) for water level detection, a first sea water control unit (V1) supplying sea water when a water level is detected by the first detection member (10) and blocks the sea water when the water level is detected by the second detection member (20), and a first pump (P1) which starts operation to transport the sewage and sea water to the electrolysis unit (E) when the water level is detected by the third detection member (30) and stops operation when the water level is detected by the first detection member (10), and wherein the second system (S2) discharges the treated water flowing in from the electrolysis unit (E) to an outside, the second system (S2) including a fifth detection member (50) a sixth detection member (60) disposed above the fifth detection member (50) for water level detection, a seventh detection member (70) disposed above the sixth detection member (60) for water level detection, and a second pump (P2) which starts operation to discharge the treated water to the outside when the water level is detected. by the sixth detection member (60) and stops operation when the water level is detected by the fifth detection member (50).

According to another embodiment of the present invention, a second sea water control unit (V2) of the sewage treatment system interworks with the first pump (P1) and supplying the sea water to the electrolysis unit (E) or blocking the sea water.

According to still another embodiment of the present invention, the second sea water control unit (V2) of the sewage treatment system supplies the sea water to the electrolysis unit (E) when the water level is detected by the third detection member (30) and blocks the sea water when the water level is detected by the first detection member (10).

According to yet still another embodiment of the present invention, the first system (S1) and the second system (S2) of the sewage treatment system are installed separately from each other or are formed as a single body with a partition positioned therebetween.

According to yet still another embodiment of the present invention, a discharging part of the second pump (P2) of the sewage treatment system includes a reducing agent supply device (R).

According to yet still another embodiment of the present invention, an alert sound goes off or light is emitted when the water level is detected by the fourth detection member (40) or the seventh detection member (70) of the sewage treatment system.

By the above-described configurations, according to the present invention, the sewage treatment system provides eco-friendly treatment of a large amount of sewage, as well as the above-described functions that go beyond the limits of the conventional sewage treatment systems. A sewage treatment system is disclosed that provides the advantages owned by the conventional, non-echo-friendly chemical treatment products and consists of eco-friendly processes and results and that overcomes the shortcomings of the conventional eco-friendly but functionally limited products.

Reviewing the effects in light of functions, the electrolysis unit of the sewage treatment system adopted according to the present invention, unlike the conventional chemical sewage treatment systems, may treat a large amount of sewage, and the sea water controller adopted according to the present invention enables automated control of supply and shutoff of sea water in a ratio for increasing electrolysis efficiency, thus leading to an increase in sewage treatment capability.

In the environmental point of view, sewage treatment is possible even without adding, chemicals for treating the sewage, and prior to the discharge of sewage that has passed through the electrolysis unit, the sewage may he neutralized again by the reducing agent supply device adopted according to the present invention. Accordingly, the present invention may comply with further tightened environmental standards.

Further, in light of user interface, the instant system may be separated or integrated to fit into the space in which the sewage treatment system is to be installed, thus allowing for a user-customized sewage treatment system.

In view of general purpose, the present invention provides to structure that may be put to use regardless of whether the user has a flush-type toilet that uses a larger amount of washing water or a vacuum-type toilet that uses a smaller amount of washing water, and is advantageous in light of wide use and economy.

Having the above-described functions and efficiencies, the sewage treatment system according to the present invention may be offered compact in configuration, in order to be suited for treating a small or large amount of sewage. Accordingly, the sewage treatment system may be utilized in any places which require an eco-friendly environment, enhanced sewage treatment, and customized installation space.

### BRIEF DESCRIPTION OF THE DRAWINGS

FIG. 1 is a view illustrating a system according to an embodiment of the present invention.

FIG. 2 is an operation flowchart for describing an operational principle of a first system according to the present invention.

FIG. 3 is an operation flowchart for describing an operational principle of a second system according to the present invention.

### DETAILED DESCRIPTION OF EMBODIMENTS

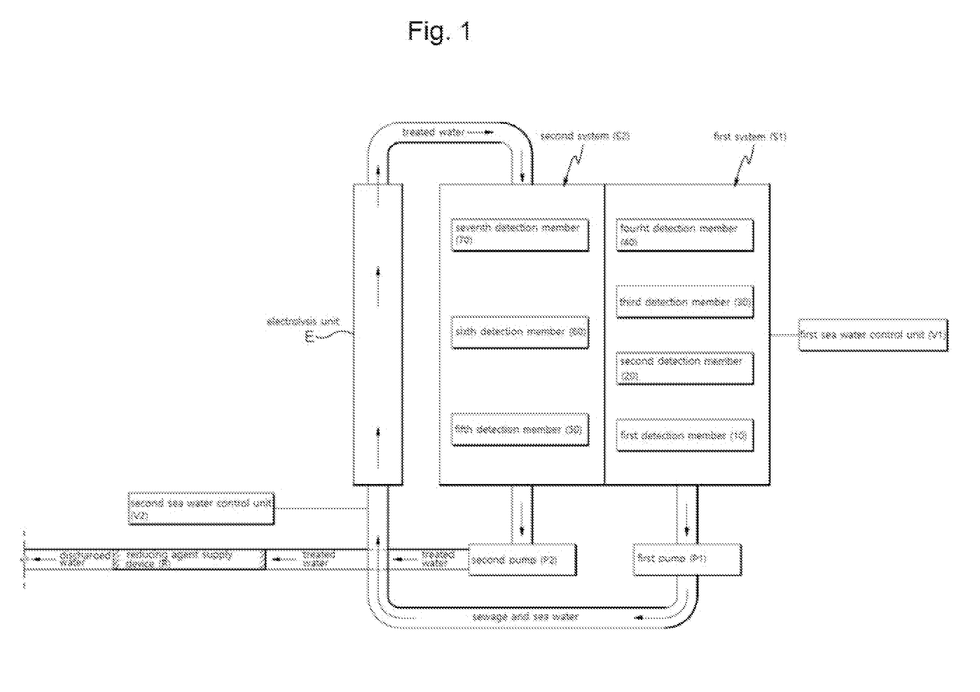

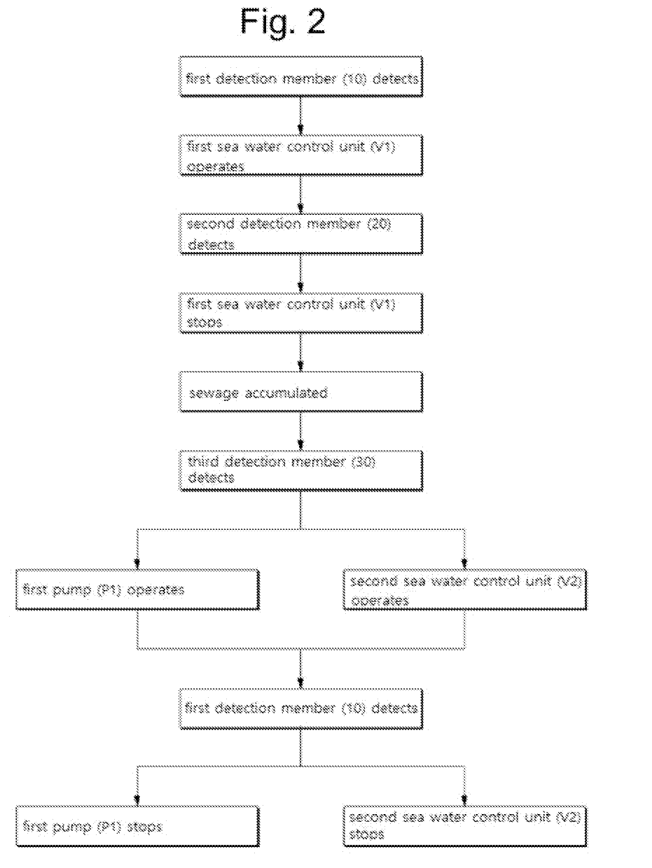

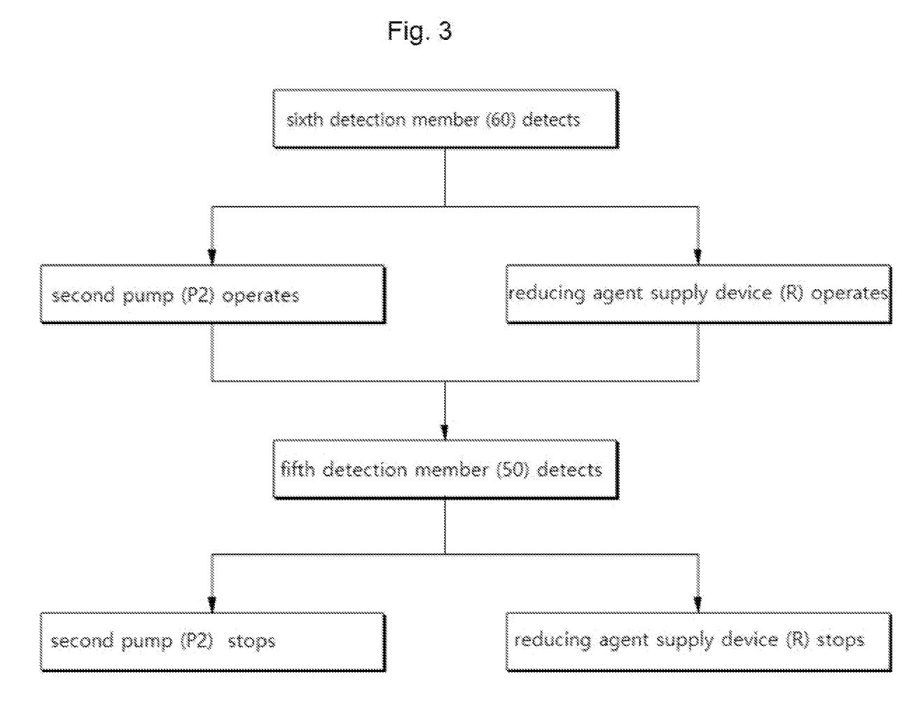

Preferable embodiments of the present invention will be described with reference to FIG. 1 through FIG. 3. According to the present invention, a sewage treatment system generally includes a first system (S1), a second system (S2), and an electrolysis unit (E).

The first system (S1) includes a first detection member (10), a second detection member (20), a third detection member (30), a fourth detection member (40), a first sea water control unit (V1), and a first pump (P1). The first detection member (10) is placed at a lowest side of the first system (S1) to detect a water level. The second detection member (20) is placed at an upper side of the first detection member (10) to detect a water level. The third detection member (30) is placed at an upper side of the second detection member (20) to detect a water level. The fourth detection member (40) is placed at an upper side of the third detection member (30) to detect a water level. When a water level is detected by the fourth detection member (40), an alert sound goes off or light is emitted to attract attention. When the detection member (10) detects a water level, the first sea water control unit (V1) supplies sea water, and if the water level reaches the second detection member (20), the first sea water control unit (V1) shuts off the sea water. The first sea water control unit (V1) supplies sea water to the first system (S1), and thus, despite accumulation of excreta in a vacuum type toilet with a small amount of washing water, sewage may be rendered to be treated without clogging the first system (S1). If a water level is detected by the third detection member (30) due to sewage accumulation, the first pump (P1) starts operation to deliver the accumulated sewage and sea water to the electrolysis unit (E), and as delivered, the water level falls. If a water level is detected by the first detection member (10), the pump (P1) stops operation. The accumulated sewage and sea water is delivered through the first system (S1) to the electrolysis unit (E).

The second system (52) includes a fifth detection member (50), a sixth detection member (60), a seventh detection member (70), and a second pump (P2). The fifth detection member (50) is placed at a lowest side of the second system (S2) to detect a water level. The sixth detection member (60) is placed at an upper side of the fifth member (50) to detect a water level, the seventh detection member (70) is placed at an upper side of sixth detection member (60) to detect a water level. If a water level is detected by the seventh detection member (70), an alert sound goes off or light is emitted to attract attention. If the sewage and sea water that have been delivered through the first pump (P1) of the first system (S1) pass through the electrolysis unit (E) and are treated, the treated water flows to the inside of the second system (S2). If a water level is detected by the sixth detection member (60) due to accumulation of the treated water, the second pump (P2) starts operation to discharge the treated water to the outside. When a water level is detected by the fifth detection member (50) due to the discharge of the treated water, the second pump (P2) stops operation. The treated water introduced from the electrolysis unit (E) is discharged to the outside through the second system (S2). A discharging part of the second pump (P2) includes a reducing agent supply device (R) and supplies a reducing agent to treated water passing through a pipe of the second pump (P2). The reducing agent may be selected from among sodium bisulphite, sodium sulfite, sulfur dioxide and sodium thiosulfate, meta sodium bisulphite or active carbon. The reducing agent supply device (R) adopted according to the present invention leads to a reduction in the concentration of chlorine in the treated water which has passed through the electrolysis unit (E). The reducing agent supply device (R) interworks with the second pump (P2). In other words, if the treated water is detected by the sixth detection member (60) of the second system (S2), the reducing agent supply device (R) starts operation simultaneously with the operation of the second pump (P2). Further, if such process goes on so that the water level of the treated water accumulated in the second system (S2) drops, in a case where a water level is detected by the fifth detection member (50) of the second system (S2), the reducing agent supply device (R) stops operation simultaneously when the second pump (P2) stops operation.

The second sea water control unit (V2) interworks with the first pump (P1) of the first system (S1), and the second sea water control unit (V2) supplies sea water to the electrolysis unit (E) or shuts off the sea water to electrolysis unit (E). In other words, when a water level is detected by the third detection member (30) of first system (S1), the first pump (PI) and the second sea water control unit (V2) simultaneously start operation. Further, if the above-described process goes on so that a water level is detected by the first detection member (S1) of first system (S1), the first pump (P1), simultaneously with the second sea water control unit (V2), stops operation. When sewage flows into the electrolysis unit (E), such operation of the second sea water control unit (V2) allows for supply of sea water to the electrolysis unit (E), thereby maximizing electrolysis efficiency. According to another embodiment of the present invention, when the third detection member (30) of the first system (S1) detects a water level of sewage, the second sea water control unit (V2) provides sea water to the electrolysis unit (E), and when the first detection ember (10) of the first system (S1) detects a lowered water level, blocks supply of the sea water to the electrolysis unit (E).

The first system (S1) and the second system (S2) as configured above may be installed separately from each other so as to fit into the space in which the sewage treatment system is installed or may be formed as a single body with a partition positioned therebetween.

Although the present invention has been described in connection with preferred embodiments thereof, it will be appreciated by one of ordinary skill in the art that various changes in form or details may be made thereto without departing from the scope of the invention defined by the following claims.

Having the above-described functions and efficiencies, the sewage treatment system according to the present invention may be offered compact in configuration, in order to be suited for treating a small or large amount of sewage. Accordingly, the sewage treatment system may be utilized in any places which require an eco-friendly environment, enhanced sewage treatment, and customized installation space.

What is claimed is:

1. A sewage treatment system comprising:
a first system (S1); and
a second system (S2), wherein the first system (S1) transports sewage and sea water to an electrolysis unit (E), the first system (S1) including:
a first detection member (10);
a second detection member (20) disposed above the first detection member (10) for water level detection;
a third detection member (30) disposed above the second detection member (20) for water level detection;
a fourth detection member (40) disposed above the third detection member (30) for water level detection:
a first sea water control unit (V1) supplying sea water when a water level is detected by the first detection member (10) and blocks the sea water when the water level is detected by the second detection member (20); and
a first pump (P1) which starts operation to transport the sewage and sea water to the electrolysis unit (E) when the water level is detected h the third detection member (30) and stops operation When the water level is detected by the first detection member (10) and wherein the second system (S2) discharges the treated water flowing in from the electrolysis unit (E) to an outside, the second system (S2) including:
a fifth detection member (50);
a sixth detection member (60) disposed above the fifth detection member (50) for water level
a seventh detection member (70) disposed above the sixth detection member (60) for water level detection; and
at second pump (P2) winch starts operation to discharge the treated water to the outside when the water level is detected by the sixth detection member (60) and stops operation when the water level is detected by the fifth detection member (50).

2. The sewage treatment system of claim 1, further comprising a second sea water control unit (V2) interworking with the first pump (P1) and supplying the sea water to the electrolysis unit (E) or blocking the sea water.

3. The sewage treatment system of claim 2, wherein the second sea water control unit (V2) supplies the sea water to the electrolysis unit (E) when the water level is detected by the third detection member (30) and blocks the sea water when the water level is detected by the first detection member (10).

4. The sewage treatment system of claim 1, wherein the first system (S1) and the second system (S2) are installed separately from each other or are formed as a single body with a partition positioned therebetween.

5. The sewage treatment system of claim 1, wherein a discharging part of the second pump (P2) includes a reducing agent supply device (R).

6. The sewage treatment system of claim 1, wherein an alert sound goes off or light is emitted when the water level is detected by the fourth detection member (40) or the seventh detection member (70).
